(19) United States
(12) Patent Application Publication
(10) Pub. No.: US 2006/0077131 A1
(43) Pub. Date: Apr. 13, 2006

(54) Driving apparatus for display panel and control method of the driving apparatus

(75) Inventor: Yoon Jung, Seoul (KR)

Correspondence Address: STANZIONE & KIM, LLP, 919 18th Street, N.W., Suite 440, Washington, DC, 20006, US

(73) Assignee: Samsung Electronics Co., Ltd.

(21) Appl. No.: 11/244,100

(22) Filed: Oct. 6, 2005

(30) Foreign Application Priority Data
Oct. 7, 2004 (KR) 2004-80040

(51) Int. Cl. G09G 3/28

(52) U.S. Cl. 345/63

(57) ABSTRACT

A driving apparatus of a display panel including a plurality of address electrodes, and a plurality of scanning electrodes, and sustaining electrodes alternately disposed as a pair, the driving apparatus comprising an address electrode driver processing an address signal and applying the address signal to one or more of address electrode lines, a temperature detector detecting a temperature of the address electrode driver, and a drive pulse generator applying the address signal to the address electrode driver, and outputting the address signal applied to the address electrode driver during an addressing period after decreasing voltage level of the address signal to a predetermined level, when detected by the temperature detector that the temperature of the address electrode driver is higher than a predetermined temperature.

### CROSS-REFERENCE TO RELATED APPLICATION

This application claims the benefit of Korean Patent Application No. 10-2004-0080040, filed on Oct. 7, 2004, which is hereby incorporated by reference for all purposes as if fully set forth herein.

### BACKGROUND OF THE INVENTION

1. Field of the Invention

The present invention relates to a driving apparatus for a display panel and a control method of the driving apparatus, and more particularly, to a driving apparatus for a display panel preventing a discharge at a high temperature and a low temperature, and displaying an image with high quality regardless of temperature variation, and a method of controlling the driving apparatus.

2. Description of the Related Art

A plasma display panel (PDP) is a flat panel display device displaying a text or graphics using light generated while gas therein is discharged. The PDP is classified as a direct current (DC) type PDP or an alternating current (AC) type PDP.

The AC-type PDP includes a plurality of cells arranged in a matrix or array. Each of the cells is surrounded by a front glass, a back glass, and a partition. Each cell of the PDP includes a scanning electrode, a sustaining electrode, and an address electrode. The PDP is typically driven by an address display period separation (ADS) driving method which applies voltage to each of the electrodes and emits light.

Referring to FIG. 1, the control of the conventional driving apparatus of the PDP according to the ADS driving method is described. The conventional driving apparatus of the PDP includes a plasma display panel 1 having a plurality of address electrodes, a plurality of scanning electrodes and sustaining electrodes alternately disposed as a pair; a video signal processor 5 converting a video signal supplied from the outside into a digital signal and generating an internal video signal; a data pulse generator 6 outputting drive controlling signals V_{z}, V_{y}, and Vₓ according to the internal video signal; an address electrode driver 2 processing an address signal V_{z} output from the data pulse generator 6 and applying a display data signal to address electrode lines; a scanning electrode driver 3 processing a scan signal V_{y} output from the data pulse generator 6 and applying the scan signal Vy to scanning electrode lines; a sustaining electrode driver 4 processing a sustain signal Vₓ output from the data pulse generator 6 and applying the sustain signal Vx to sustaining electrode lines.

Thus, the driving apparatus of the PDP is driven by circulating a reset period that uniformly eliminates wall charge for all cells of the PDP, an addressing period that forms the wall charge in a predetermined cell, and a sustain discharge period that generates and maintains gas discharge. Particularly, as the wall charge is formed inside of the predetermined cell, plasma is generated even when the sustaining electrode receives a small voltage during the sustain discharge period. The wall charge of the addressing period is formed by voltage differences between the address signal V_{z} applied to the address electrode and the scan signal V_{y} applied to the scanning electrode during the addressing period, and between the voltage level Vₓ applied to the sustaining electrode and the sustain signal.

However, the conventional driving apparatus of the PDP has excessive priming effects of the gas within the display panel 1 at a high temperature and current flowing in the address electrode increases, thereby increasing load current and causing damage to components thereof. Thus, the conventional driving apparatus of the PDP artificially reduces the number of some subfields at a higher temperature than is necessary to prevent the increase of the load current and the damage of the components. However, diffusion occurs and a picture quality deteriorates accordingly as a gradation of color thereof is damaged.

The conventional driving apparatus of the PDP cannot discharge enough gas since the priming effects are insufficient due to a shortage of motion energy of the gas at a low temperature.

### SUMMARY OF THE INVENTION

It is an aspect of the present invention to provide a driving apparatus for a display panel preventing an unusual discharge at a high temperature and a low temperature, and displaying an image with high quality regardless of temperature variation therearound and a control method of the driving apparatus. Additional features of the invention will be set forth in the description which follows, and in part will be apparent from the description, or may be learned by practice of the invention.

The present invention discloses a driving apparatus of a display panel including an address electrode driver processing an address signal, a temperature detector detecting a temperature of the address electrode driver, and a drive pulse generator applying the address signal to the address electrode driver and outputting the address signal during an addressing period after decreasing a voltage level of the address signal to a predetermined level when the temperature of the address electrode driver is higher than a predetermined temperature.

The present invention also discloses a method of controlling a driving apparatus of a display panel having an address electrode driver processing an address signal, including detecting whether a temperature of the address electrode driver is higher than a first temperature, decreasing a voltage level of the address signal to a predetermined level when the temperature of the address electrode driver is higher than the first temperature; and outputting the address signal applied to the address electrode driver.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a conventional driving apparatus of a display panel.

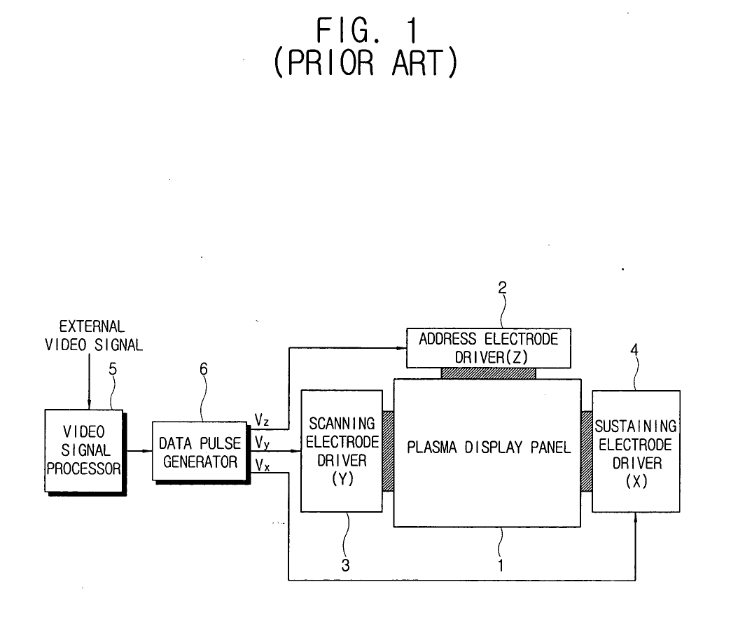

FIG. 2 is a control block diagram of a driving apparatus of a display panel according to an embodiment of the invention.

FIG. 3 is a partial control block diagram of an increase/decrease circuit according to an embodiment of the invention.

FIG. 4 shows a drive motion margin during an addressing period at a normal, low, and high temperature of the driving apparatus of the display panel according to an embodiment of the invention.

FIG. 5 is a control flow chart of the driving apparatus of the display panel according to an embodiment of the invention.

### DESCRIPTION OF THE ILLUSTRATED EMBODIMENTS

Reference will now be made in detail to the embodiments of the present invention, examples of which are illustrated in the accompanying drawings, wherein like reference numerals refer to like elements throughout.

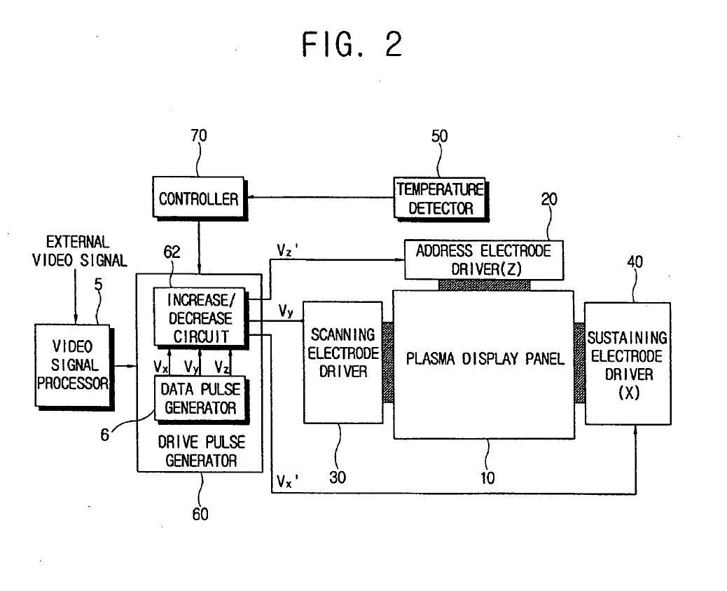

FIG. 2 is a control block diagram of a driving apparatus of a display panel according to an embodiment of the invention.

Referring to FIG. 2, the driving apparatus of the display panel may include a plasma display panel 10 having a plurality of address electrodes, and a plurality of scanning electrodes and sustaining electrodes alternately disposed as a pair; a video signal processor 5 converting a video signal, which may be externally supplied, into a digital signal and generating an internal video signal; a drive pulse generator 60 converting drive control signals V_{z}, V_{y}, and Vₓ according to the internal video signal into V_{z}′, V_{y}′ and Vₓ′ and outputting the converted drive control signals V_{z}′, V_{y}′ and Vₓ′.

The driving apparatus may further include an address electrode driver 20 processing an address signal V_{z}′ supplied from the drive pulse generator 60 and applying a display data signal to the address electrode lines; a scanning electrode driver 30 processing a scan signal V_{y} supplied from the drive pulse generator 60 and applying the scan signal V_{y} to the scanning electrode lines; a sustaining electrode driver 40 processing a sustain signal Vₓ′ supplied from the drive pulse generator 60 and applying the sustain signal Vₓ′ to the sustaining electrode lines; and a temperature detector 50 detecting a temperature of the address electrode driver 20.

The driving apparatus may further include a controller 70 controlling the drive pulse generator 60 to increase or decrease a voltage level of the address signal V_{z} and the sustain signal Vₓ output during the addressing period according to the temperature of the address electrode driver 20.

The video signal processor 5 converts the externally supplied video signal supplied into a digital signal and generates the internal video signal and outputs the internal video signal to the drive pulse generator. For example, the internal video signal may include red, green, and blue video data respectively having eight bits, a clock signal, a vertical sync signal, and a horizontal sync signal.

The drive pulse generator 60 includes a data pulse generator 6 and an increase/decrease circuit 62.

The data pulse generator 6 controls the address electrode driver 20, the scanning electrode driver 30, and the sustaining electrode driver 40 by outputting the drive control signals V_{z}, V_{y} and Vₓ, respectively, according to the internal video signal supplied from the video signal processor 5.

The increase/decrease circuit 62 may output the address signal V_{z} and the sustain signal Vₓ to the address electrode driver 20 and the sustaining electrode driver 40 without changing the address signal V_{z} and the sustain signal Vₓ. Alternatively, the increase/decrease circuit 62 may output the address signal V_{z}′ and the sustain signal Vₓ′ after increasing or decreasing the voltage level of at least one of the address signal V_{z} and the sustain signal Vₓ to a predetermined level according to a predetermined control.

The controller 70 controls the increase/decrease circuit 62 decrease the voltage level of the address signal V_{z} during the addressing period to a predetermined level when the temperature detector 50 detects that the temperature of the address electrode driver 20 is greater than a first predetermined temperature. The increase/decrease circuit 62 then outputs the address signal V_{z} to the address electrode driver 20. This prevents or excessively reduces the excessive priming effects of the gas during the addressing period at the high temperature and the expansion of the current flowing in the address electrode.

The controller 70 controls the increase/decrease circuit 62 to increase the voltage level of the address signal V_{z} during the addressing period to a predetermined level when the temperature detector 50 detects that the temperature of the address electrode driver 20 is lower than a second predetermined temperature. The second predetermined temperature is lower than the first predetermined temperature. Thus, the gas is sufficiently discharged by guaranteeing the priming effects due to the motion energy of the gas during the addressing period at the low temperature.

When the temperature detector 50 detects that the temperature of the address electrode driver 20 is greater than the first temperature or lower than the second temperature, the controller 70 controls the increase/decrease circuit 62 to output the sustain signal Vₓ′ to the sustaining electrode driver 40 after increasing the voltage level of the sustain signal Vₓ to a predetermined level. Thus, a sufficient discharge is formed between the sustaining electrodes, e.g., the scan signal V_{y} and the sustain signal Vₓ′.

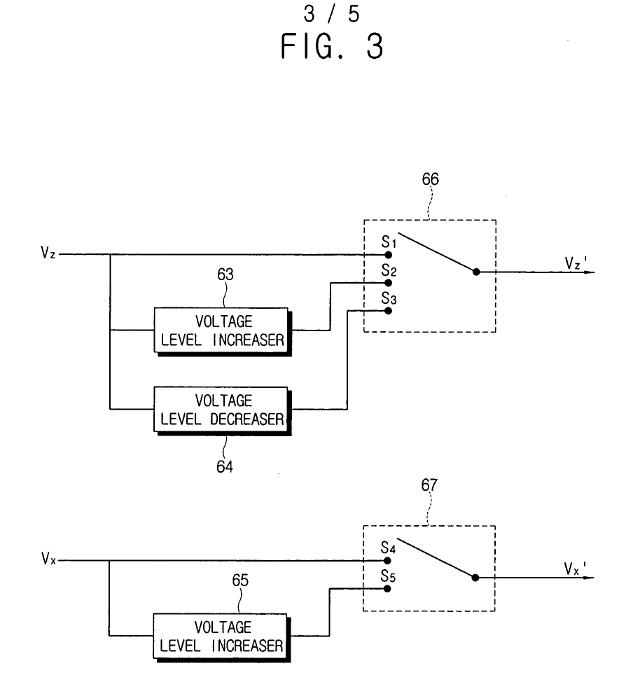

An embodiment of the increase/decrease circuit 62 is described below with reference to FIG. 3.

Referring to FIG. 3, the increase/decrease circuit 62 includes a voltage level increaser 63 and a voltage level decreaser 64. The voltage level increaser 63 and the voltage level decreaser 64 are parallel to an input line receiving the address signal V_{z} from the data pulse generator 6.

The increase/decrease circuit 62 may further include a first switch 66 that outputs the address signal V_{z} supplied from the data pulse generator 6 to the address electrode driver 20 without changing the address signal V_{z} through the controller 70. Alternatively, the first switch 66 of the data pulse generator 6 may output the address signal V_{z}′ supplied from the voltage level increaser 63 or the voltage level decreaser 64 to the address electrode driver 20 through the controller 70.

The increase/decrease circuit 62 may further include a voltage level increaser 65 that is parallel to an input line receiving the sustain signal Vₓ from the data pulse generator 6; and a second switch 67 that outputs the sustain signal Vₓ received from the data pulse generator 6 to the sustaining electrode driver 40 without changing the sustain signal Vₓ through the controller 70, or outputs the sustain signal Vₓ′ received from the voltage level increaser 65 to the sustaining electrode driver 40 through the controller 70.

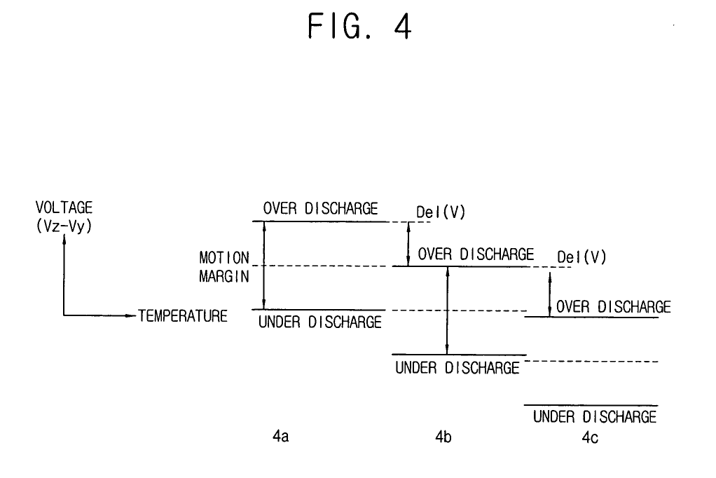

The voltage level increasers 63 and 65 output the address signal V_{z} and the sustain signal Vₓ after increasing the voltage level of the address signal V_{z} and the sustain signal Vₓ to a predetermined level. According to an embodiment of the invention, as shown in FIG. 4, the predetermined level may be one-half {del (V)/2} of the voltage variation of the motion margin according to the temperature of the addressing period. It is understood that the predetermined level is not limited to one-half of the voltage variation of the motion margin.

The voltage level decreaser 64 outputs the address signal V_{z} after decreasing the voltage level of the address signal V_{z} to a predetermined level. According to an embodiment of the invention, as shown in FIG. 4, the predetermined level may be one-half {del (V)/2} of the voltage variation of the movement margin according to the temperature of the addressing period. It is understood that the predetermined level is not limited to one-half of the voltage variation of the motion margin.

According to an embodiment of the invention shown in FIG. 3, when the temperature of the address electrode driver 20 is between the first temperature and the second temperature, the first switch 66 of the increase/decrease circuit 62 contacts a terminal S1 and the second switch 67 contacts a terminal S4. At this time, the drive motion margin of the display panel is the same as of the drive motion margin of the conventional driving apparatus. The temperature is detected by the temperature detector 50.

According to an embodiment of the invention shown in FIG. 3, when the temperature of the address electrode driver is higher than the first predetermined temperature, controller 70 controls the first switch 66 to contact a terminal S3 and the second switch 67 to contact a terminal S5 during the addressing period. The controller 70 controls the first switch 66 to contact a terminal S2 and the second switch 67 to contact a terminal S5 during the addressing period when the temperature of the address electrode driver 20 is lower than the second temperature. The temperature is detected by the temperature detector 50.

FIG. 4 illustrates an example of the drive motion margin of the addressing period of the display panel according to an embodiment of the invention at a normal, low and high temperature. The drive motion margin is within the address signal V_{z} and the scan signal V_{y} capable of normally moving during the addressing period.

4b of FIG. 4 shows an example of the drive motion margin of the addressing period at a normal temperature. For example, 4b is a motion margin that occurs during the addressing period. The motion margin of 4b is the drive motion margin of the driving apparatus of the display panel when the temperature of the address electrode driver 20 is between the first temperature and the second temperature and the first switch 66 contacts the terminal S1.

4c of FIG. 4 shows an example of the drive motion margin of the addressing period at a low temperature. The drive motion margin of the address electrode driver 20 has a range shown in 4c when the temperature of the address electrode driver 20 is lower than the second temperature because setting all voltage to correspond to the drive motion margin shown in 4b, e.g., a general plasma display setting, may trigger an insufficient discharge. Accordingly, a stable discharge may be generated by compensating the voltage through having the first switch 66 contact the terminal S2 and the second switch 67 contact the terminal S5 during the addressing period.

4a in FIG. 4 shows an example of the drive motion margin of the addressing period at a high temperature. The drive motion margin of the address electrode driver 20 has a range shown in 4a when the temperature of the address electrode driver 20 is higher than the first temperature because setting all voltage to correspond to the drive motion margin shown in 4b, e.g., a general plasma display setting, may trigger an excessive discharge. Further, a thermal runaway due to the discharge may raise the temperature of the address electrode driver 20, thereby damaging an integrated circuit (IC). Accordingly, a stable discharge may be generated by compensating the excessive voltage through having the first switch 66 contact the terminal S3 and having the second switch 67 contact the terminal S5 during the addressing period.

One reason for raising the voltage of the Vₓ is to efficiently lead the discharge generated by the low voltage V_{z} during the addressing period to the scanning electrode and the sustaining electrode. Generally, a part of the subfields is excluded to prevent the thermal runaway. However, such exclusion deteriorates the gradation of the PDP 1 and the picture quality. The temperature compensation circuit enables an increase of the current to be restrained due to the low voltage V_{z} at a high temperature, which allows a high picture quality to be maintained at a high temperature as the gradation remains unchanged.

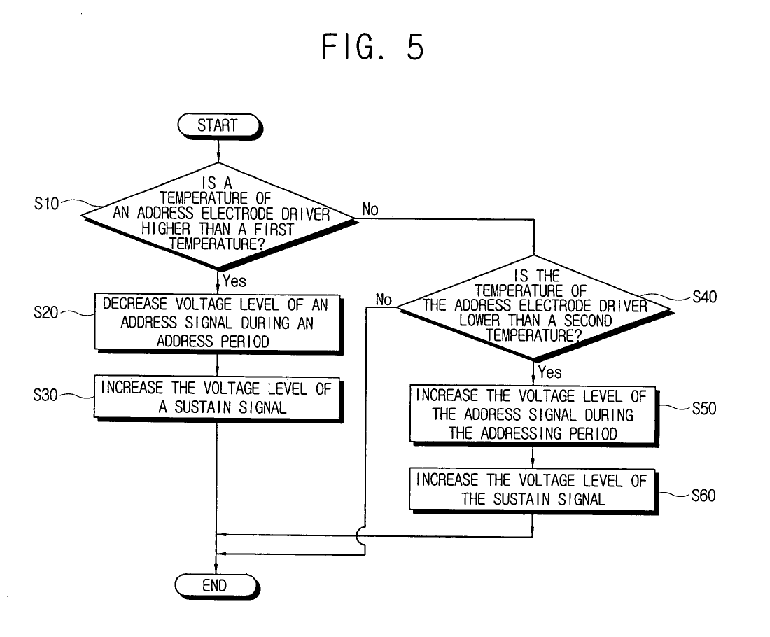

FIG. 5 shows a method of controlling the driving apparatus of the display panel according to an embodiment of the invention.

In operation S10, a temperature of the address electrode driver 20 is detected and it is determined whether the detected temperature is higher than a first predetermined temperature.

When the temperature of the address electrode driver 20 is higher than the first temperature, a controller 70 controls an increase/decrease circuit 62 to decrease the voltage level of the address signal V_{z} output to the address electrode driver 20 during the addressing period, and outputs the address signal V_{z} at operation S20.

When the temperature of the address electrode driver 20 is higher than the first temperature, the controller 70 controls the increase/decrease circuit 62 to increase the voltage level of the sustain signal Vₓ output to the sustaining electrode driver 40, and outputs the sustain signal Vₓ at operation S30. Outputting the increased voltage level of the sustain signal Vₓ enables a sufficient discharge to form between the sustaining electrodes, e.g., the scan signal V_{y} and the sustain signal Vₓ′.

When the temperature of the address electrode driver 20 is lower than the first temperature at operation S10, the temperature of the address electrode driver 20 is detected and it is determined whether the detected temperature is lower than the second temperature at operation S40.

When the temperature of the address electrode driver 20 is lower than the second temperature, the controller 70 controls the increase/decrease circuit 62 to increases the voltage level of the address signal V_{z} output to the address electrode driver 20 during the addressing period and output the address signal V_{z} at operation S50.

When the temperature of the address electrode driver 20 is lower than the second temperature, the controller 70 controls the increase/decrease circuit 62 to increase the voltage level of the sustain signal Vₓ output to the sustaining electrode driver 40 and outputs the sustain signal Vₓ at operation S60. Increasing and outputting the voltage level of the sustain signal at operation S60 enables a sufficient discharge to form between the sustaining electrodes, e.g., the scan signal V_{y} and the sustain signal Vₓ′.

According to an embodiment of the invention, the driving apparatus of the display panel adjusts the drive motion voltage of the addressing period to correspond with the motion margin at a sufficiently high temperature, thereby preventing the excessive priming effects of the gas within the PDP 1 and the expansion of the current flowing in the address electrode.

According to an embodiment of the invention, the driving apparatus of the display panel adjusts the driving movement voltage of the addressing period to correspond with the motion margin at a low temperature, thereby enabling the gas to be sufficiently discharged due to sufficient priming effects.

According to an embodiment of the invention, the driving apparatus of the display panel prevents a discharge at a high temperature and a low temperature, and displays a picture with high quality regardless of temperature variation.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus for driving a display panel, comprising:
an address electrode driver processing an address signal;
a temperature detector detecting a temperature of the address electrode driver; and
a drive pulse generator applying the address signal to the address electrode driver and outputting the address signal during an addressing period after decreasing a voltage level of the address signal to a predetermined level when the temperature of the address electrode driver is higher than a predetermined temperature.

2. The apparatus of claim 1, wherein the drive pulse generator outputs the address signal to the address electrode driver after decreasing the voltage level of the address signal to a predetermined level when the temperature of the address electrode driver is higher than a first temperature and outputs the address signal to the address electrode driver after increasing the voltage level of the address signal to a predetermined level when the temperature of the address electrode driver is lower than a second temperature.

3. The apparatus of claim 2, wherein the display panel comprises:
a plurality of address electrode lines; and
a plurality of scanning electrode lines and sustaining electrode lines alternately disposed as a pair.

4. The apparatus of claim 3, further comprising:
a sustaining electrode driver processing a sustain signal;
wherein the drive pulse generator outputs the sustain signal to the sustaining electrode driver after increasing the voltage level of the sustain signal to a predetermined level when the temperature of the address electrode driver is lower than the second temperature.

5. The apparatus of claim 4, wherein the drive pulse generator outputs the sustain signal to the sustaining electrode driver after increasing the voltage level of the sustain signal to a predetermined level when the temperature of the address electrode driver is higher than the first temperature.

6. The apparatus of claim 4, wherein the drive pulse generator comprises:
a data pulse generator driving the address electrode driver and the sustaining electrode by outputting the address signal and the sustain signal, respectively; and
an increase/decrease circuit receiving the address signal and the sustain signal from the data pulse generator and either outputting the address signal and the sustain signal received from the data pulse generator to the address electrode driver and the sustaining electrode driver, or changing at least one voltage level between the address signal and the sustain signal to a predetermined level before outputting the address signal and the sustain signal to the address electrode driver and the sustaining electrode driver.

7. The apparatus of claim 6, further comprising:
a controller controlling the increase/decrease circuit to output the address signal to the address electrode driver after decreasing the voltage level of the address signal to the predetermined level when the temperature of the address electrode driver is higher than the first temperature.

8. The apparatus of claim 7, wherein the controller controls the increase/decrease circuit to output the address signal to the address electrode driver after increasing the voltage level of the address signal to the predetermined level when the temperature of the address electrode driver is lower than the second temperature.

9. The apparatus of claim 8, wherein the controller controls the increase/decrease circuit to output the sustain signal after increasing the voltage level of the sustain signal to the predetermined level when the temperature of the address electrode driver is higher than the first temperature or lower than the second temperature.

10. A method of controlling a driving apparatus of a display panel having an address electrode driver processing an address signal, comprising:
detecting whether a temperature of the address electrode driver is higher than a first temperature; and
decreasing a voltage level of the address signal to a predetermined level when the temperature of the address electrode driver is higher than the first temperature; and
outputting the address signal applied to the address electrode driver.

11. The method of claim 10, further comprising:
detecting whether the temperature of the address electrode driver is lower than a second predetermined temperature that is lower than the first temperature;
increasing the voltage level of the address signal to a predetermined level when the temperature of the address electrode driver is lower than the second temperature; and
outputting the address signal applied to the address electrode driver.

12. The method of claim 11, further comprising:
processing a sustain signal and applying the sustain signal to a plurality of sustaining electrode lines,
wherein a voltage level of the sustain signal is increased to a predetermined level when the temperature of the address electrode driver is higher than the first temperature or lower than the second temperature.
